(19) United States
(12) Patent Application Publication
(10) Pub. No.: US 2006/0248701 A1
(43) Pub. Date: Nov. 9, 2006

(54) Hammer

(76) Inventors: Ralf Bernhart, Idstein (DE); Achim Buchholz, Limburg (DE)

Correspondence Address: Michael P. Leary, Sr. Group Patent Counsel;Black & Decker Corporation, 701 E. Joppa Rd, TW199, Towson, MD, 21286, US

(21) Appl. No.: 11/479,869

(22) Filed: Jun. 30, 2006

Related U.S. Application Data
(62) Division of application No. 10/844,234, filed on May 12, 2004, now abandoned.

(30) Foreign Application Priority Data
May 12, 2003 (GB) GB 0310774.5

(51) Int. Cl. B25D 11/00

(52) U.S. Cl. 29/428; 173/128; 173/201

(57) ABSTRACT

This patent relates to a method of assembling a spindle assembly comprising: a tubular spindle (2); a beat piece structure which is capable of being located and slid within a part (6) of the spindle (2); a stop mechanism (20) located within the spindle (2) which prevents the beat piece structure from sliding past it when the beat piece structure is located in and sliding within the spindle (2); and a retention mechanism capable of being located within the spindle (2) and which prevents the beat piece structure from sliding past it when the beat piece structure is located in and sliding within the spindle (2); wherein the method comprises the steps of:
i) inserting the beat piece structure into the spindle through one end of the spindle and sliding it along the spindle (2) in one direction until it abuts the stop mechanism (20);
ii) inserting the retention mechanism into the spindle through the same end of the spindle (2) until it locates at a predetermined position;
iii) sliding the beat piece structure in the opposite direction away from the stop mechanism (20) until it abuts the retention mechanism 106. It also covers a spindle constructed by such a method.

### FIELD OF THE INVENTION

The present invention relates to hammer drills, and in particular to a spindle assembly, and more in particular, to a spindle assembly comprising a ram catcher, a bush damper, a bearing beat piece and a beat piece mounted within the rotary spindle, and a method of assembly of such a spindle assembly.

### BACKGROUND OF THE INVENTION

A typical hammer drill is capable of operating in at least two modes of operation, a hammer only mode where the end of a drill bit located within the tool holder of the drill is repeatedly struck, usually by a beat piece, and a hammer and drill mode, where the end of the drill bit is repeated struck whilst the drill bit is rotated. Such drills typically consist of a spindle in which is located a ram which is reciprocatingly driven within the spindle by a reciprocating piston which is driven by a motor. The reciprocating ram strikes the beat piece which in turn strikes the end of the drill bit located within the tool holder. The spindle can also be rotatingly driven by the motor via gearing. Internal mode change mechanisms enable the hammer drill to operate in and change between the modes of operation. However, such hammer drills are complex in construction which result in complicated manufacturing procedures. It is therefore desirable to simplify to such procedures and to construct such a drill in a manner that simple construction procedures can be utilised.

### BRIEF SUMMARY OF THE INVENTION

According to the first aspect of the present invention, there is provided a method of assembling a spindle assembly comprising:
a tubular spindle;
a beat piece structure which is capable of being located and slid within a part of the spindle;
a stop mechanism located within the spindle which prevents the beat piece structure from sliding past it when the beat piece structure is located in and sliding within the spindle;
and a retention mechanism capable of being located within the spindle and which prevents the beat piece structure from sliding past it when the beat piece structure is located in and sliding within the spindle;
wherein the method comprises the steps of:
   inserting the beat piece structure into the spindle through one end of the spindle and sliding it along the spindle in one direction until it abuts the stop mechanism;
   inserting the retention mechanism into the spindle through the same end of the spindle until it locates at a predetermined position;
   sliding the beat piece structure in the opposite direction away from the stop mechanism until it abuts the retention mechanism.

According to the second aspect of the present invention, there is provided a method of disassembling a spindle assembly comprising:
a tubular spindle;
a beat piece structure located in and capable of being slid within a part (6) of the spindle;
a stop mechanism located within the spindle on one side of the beat piece structure with a space there between and which prevents the beat piece structure from sliding past it when the beat piece structure is slid within the spindle;
and a removeable retention mechanism located within the spindle adjacent the beat piece structure on the opposite side of it to that of the stop mechanism which prevents the beat piece structure from sliding past;
wherein the method comprises the steps of:
   sliding the beat piece structure in a direction away from the retention mechanism into the space between the beat piece structure and the stop mechanism until it abuts the stop mechanism;
   removing the retention mechanism from the spindle;
   removing the beat piece structure from the spindle through the same end of the spindle as the retention mechanism.

According to the third aspect of the present invention, there is provided a spindle assembly comprising:
a tubular spindle;
a beat piece structure located in and capable of being slid within a part of the spindle;
a stop mechanism located within the spindle on one side of the beat piece structure and which prevents the beat piece structure from sliding past it when the beat piece structure is slid within the spindle;
and a removeable retention mechanism located within the spindle adjacent the beat piece structure on the opposite side of it to that of the stop mechanism which prevents the beat piece structure from sliding past;
wherein a space is provided between the stop mechanism and the beat piece structure and the retention mechanism abuts against the retention mechanism.

### BRIEF DESCRIPTION OF THE DRAWINGS

An embodiment of the present invention will no be described with reference to following drawings of which:

FIG. 1 shows a vertical cross section of the front end of a hammer drill;

FIG. 2 shows a vertical cross section of a spindle assembly during a first phase of assembly;

FIG. 3 shows a vertical cross section of the spindle assembly during a second phase of assembly; and

FIG. 4 shows a vertical cross section of the spindle assembly during a second phase of assembly;

FIG. 5 shows a computer generated picture of a vertical cross section of the spindle assembly from the side;

FIG. 6 shows a computer generated picture of a vertical cross section of the spindle assembly from a rear perspective view; and

FIG. 7 shows a computer generated picture of a vertical cross section of the spindle assembly from a front perspective view.

### DETAILED DESCRIPTION OF THE INVENTION

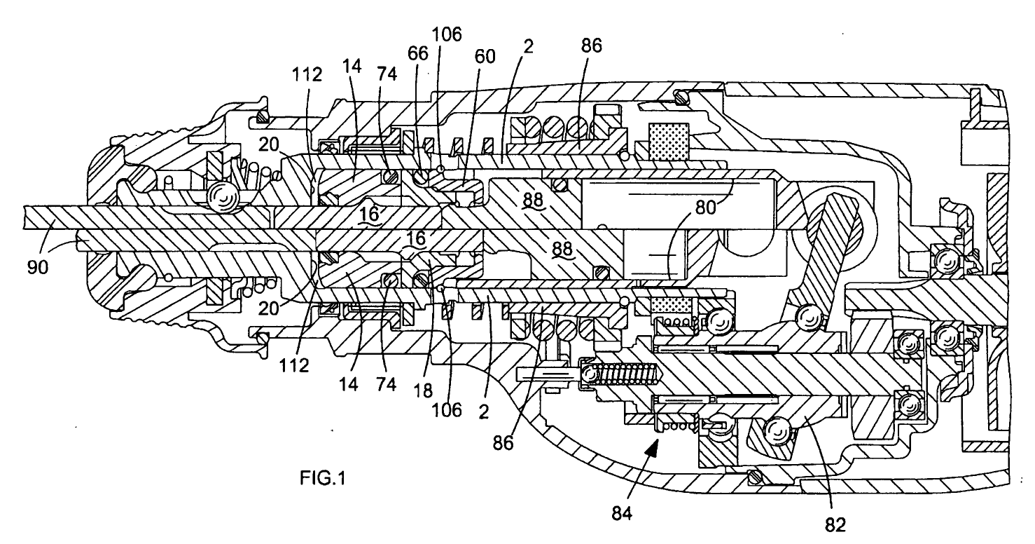

Referring to FIG. 1, a hammer comprises a body in which is mounted an electric motor (not shown) which drives the hammer. The electric motor is capable of driving a hollow piston 80 in a reciprocating manner via a wobble bearing 82 which in turn is connected to the electric motor via a gear mechanism generally indicated by reference number 84. The hollow piston 80 is located within a tubular spindle 2 which is capable of being rotatingly driven via a drive sleeve 86 which in turn is rotatingly driven via the gear mechanism generally shown at 84. The hollow piston 80 reciprocatingly drives a ram 88 within the hollow piston 80 and which is used to strike a beat piece 16 which in turn strikes the end of the drill bit 90 located within a tool holder generally indicated at.

The gear mechanism generally indicated at 84 enables the wobble drive and/or the drive sleeve 86 of the spindle 2 to be disconnected from the rotary drive of the electric motor. As the gear mechanism 84 forms no part of the present invention it is not described in any further detail. The mechanism by which the hammer action and the drilling action of the hammer is performed is well known in the art and therefore also will not be described further.

The present invention relates to the construction of the spindle assembly and in particular to a method of construction of the beat piece arrangement within the spindle.

As mentioned previously, the hammer comprises a tubular spindle 2 which is capable of being rotationally driven by the electric motor. The spindle 2 is hollow and circular in cross section along its length and is made in a one piece construction from steel.

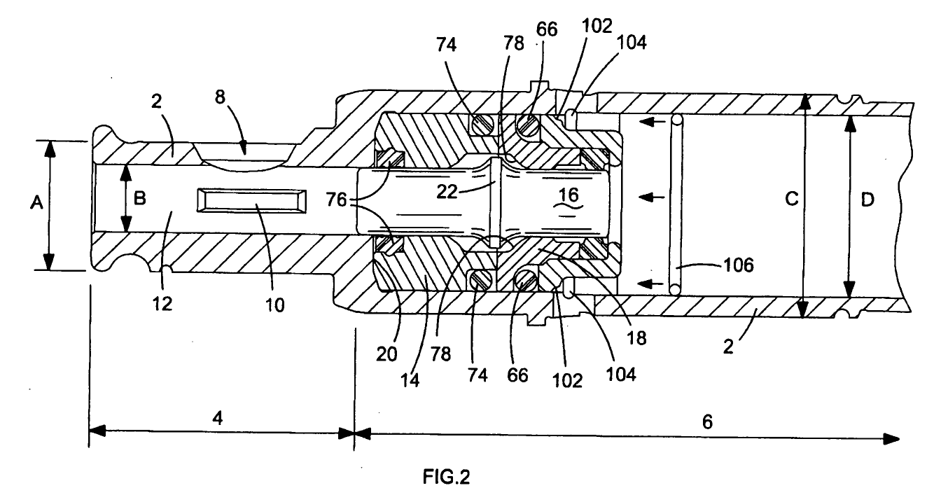

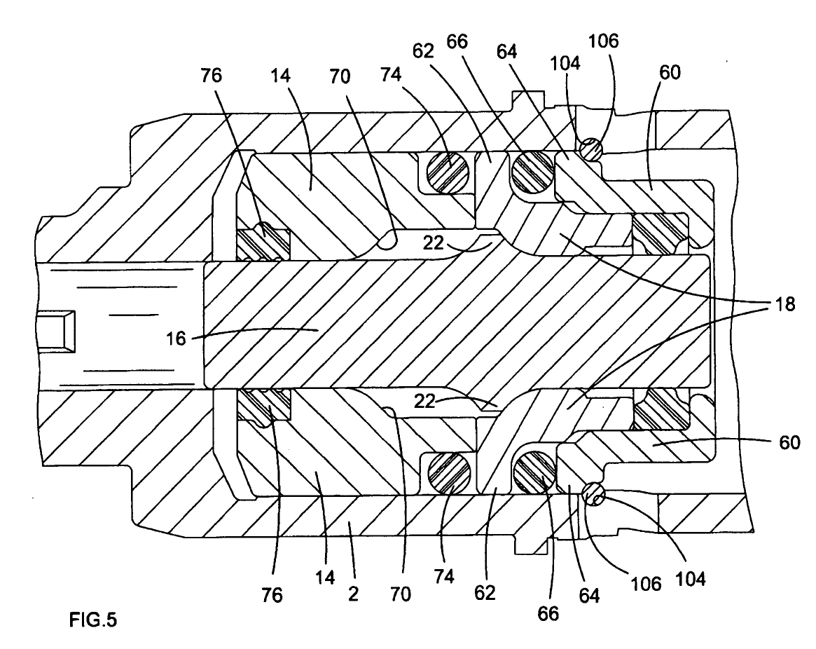

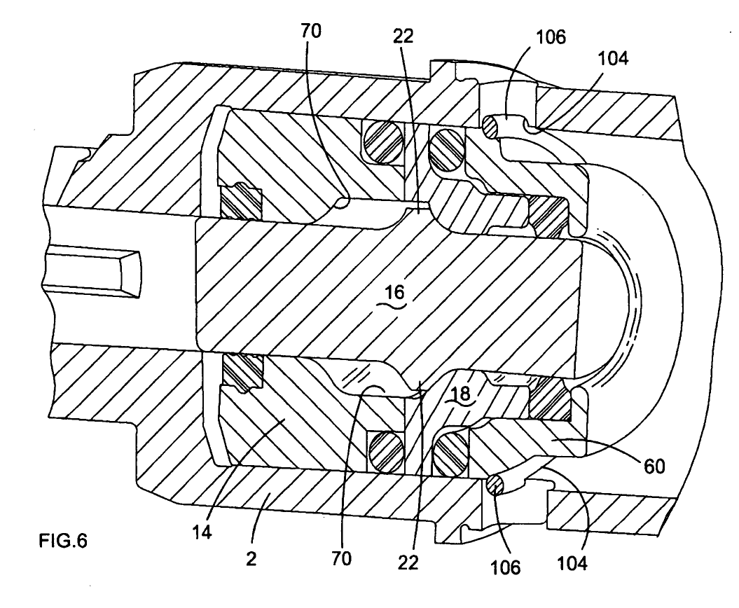

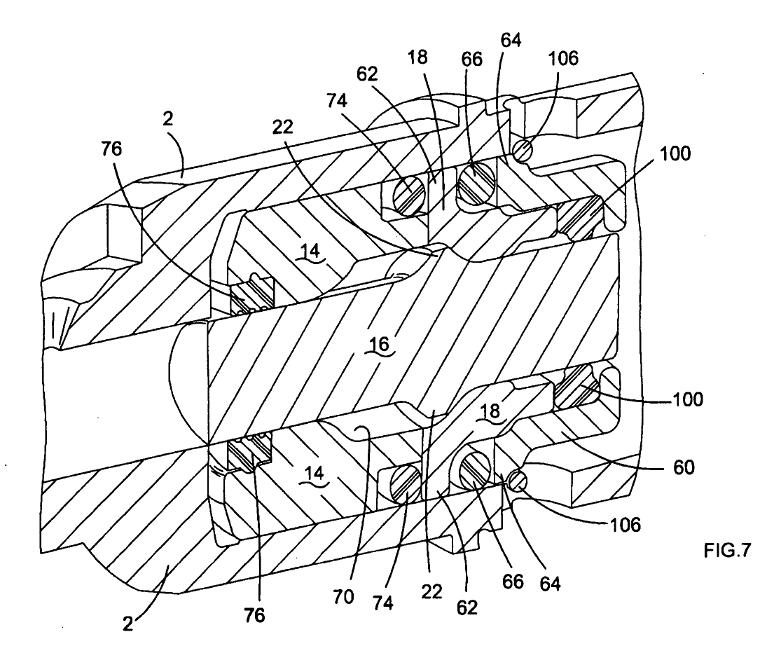

Referring to FIGS. 2 to 7, the spindle 2 comprises two sections, a first tubular section 4 of circular cross section at the working end of the spindle 2 having a first outer diameter A and a first inner diameter B; and a second tubular section 6 of circular cross section towards the rear of the hammer having a second outer diameter C which is greater than the first outer diameter A and a second inner diameter D which is greater than the first inner diameter B. A shoulder 20 is formed between the sections 4, 6.

Formed on the inner wall 12 of the first section 4 of the spindle 2 are two splines 10 (only one is shown). An aperture 8 is formed through the wall of the first section 4 of the spindle 2. The splines 10 and the hole 8 form part of a locking mechanism, more of which is shown in FIG. 1 for an SDS drill bit 90, the end of the shaft of which is inserted into the first section 4 in order to be attached to the first part of the spindle 2 by the locking mechanism. The locking mechanism and SDS drill bits do not form part of this invention and therefore will not be described in any more detail.

Located in the second section 6 of the spindle 2 is a beat piece support mechanism which has two parts, a bearing beat piece 14 and a bush damper 18 which both support a beat piece 16 located within the bearing beat piece 14 and bush damper 18. The bearing beat piece 14 is mounted between the bush damper 18 and the shoulder as shown in FIG. 2 to 4.

The beat piece 16 is a solid bar of circular cross section along its length. An annular rib 22 is formed around the outer circumference of the beat piece 16 which projects radially outwards.

The bearing beat piece 14 is tubular and circular in cross section. Its outer diameter is fractionally less than that of the inner diameter D of the second section 6 of the spindle 2. The inner diameter of the bearing beat piece 14 is fractionally larger than that of the beat piece 16 enabling the beat piece 16 to be located within it as shown. A ledge 70 is formed in the inner surface of the bearing beat piece 14 at one end of the bearing beat piece 14 so that its inner diameter is larger than the rest of the inner surface of the bearing beat piece 14. The size of the ledge 70 is such that the annular rib 22 of the beat piece 16 can be located within the space created by the ledge. When the bearing beat piece 14 is located within the spindle, the end which contains the ledge 70 faces the bush damper 18. A groove 72 is formed around the outer surface of the end containing the ledge in which is located a rubber O ring 74. A second groove is formed in the inner surface of the bearing beat piece 14 close to the other end in which is located a seal 76.

The bush damper 18 is also tubular and circular in cross section. Its outermost diameter is fractionally less than that of the inner diameter D of the second section 6 of the spindle 2. The innermost diameter of the bush damper 18 is fractionally larger than that of the beat piece 16 enabling the beat piece 16 to be located within it as shown. A ledge 78 is formed in the inner surface of the bush damper 18 at one end of the bush damper 18 so that its inner diameter in the ledge is larger than the rest of the innermost surface of the bush damper 18. The size of the ledge is the same as that in the bearing beat piece 14 and as such enables the annular rib 22 of the beat piece 16 to be located within the space created by the ledge 78. When the bush damper 18 is located within the spindle, the end which contains the ledge 78 faces the bearing beat piece 14. The two ledges 70, 78 create a space in which the rib 22 of the beat piece 16 can be located and slide as the beat piece 16 slides within the bearing beat piece 14 and bush damper 18.

A ram catch 60 is mounted within the spindle adjacent the bush damper 18 on the opposite side of the bush damper 18 to that of the bearing beat piece 14 as shown in FIGS. 2 to 7. The ram catcher 60 is also tubular and circular in cross section. Its outermost diameter is fractionally less than that of the inner diameter D of the second section 6 of the spindle 2. The innermost diameter of the bush damper 18 is larger than that of the beat piece 16 enabling the beat piece 16 to pass through it. The ram catcher 60 partially surrounds the bush damper 18 as shown.

A flange 62 is formed on the bush damper 18 at its radially outermost position. Similarly a flange 64 is formed on the ram catcher at its radially outermost position. An O ring 66 is sandwiched between the two flanges 62, 64 as shown. A second flange 68 is formed on the ram catcher 60 at its radially inner most position. A ram catcher ring 100 is sandwiched between the end the bush damper 18 and the second flange 68. An annular recess 102 is formed in the outermost flange 64 of the ram catcher 60 which faces away from the bush damper 18 as shown in FIG. 2 to 7.

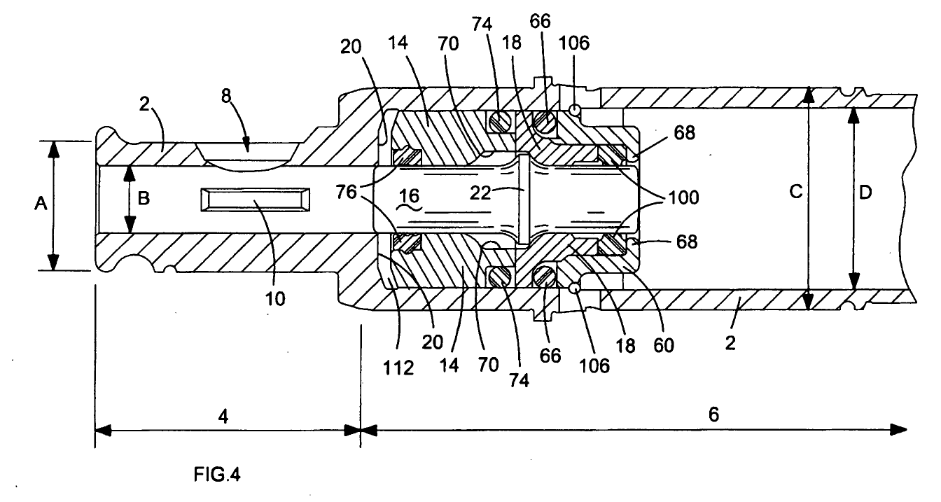

A groove 104 is formed in the inner wall of the spindle 2. A circlip 106 is located within the groove 102 to prevent the ram catcher 60, the bush damper 18 and bearing beat piece 14 from sliding past it. When fully assembled, the circlip 106 locates within the annular recess 102 of the outermost flange 64 of the ram catcher 60 as shown in FIGS. 4 to 7.

The function of the beat piece 16, beat piece support mechanism, the ram catcher 60 and ram catcher ring 100 is well known and will not be described in any more detail.

The method by which the structure is assembled will now be described.

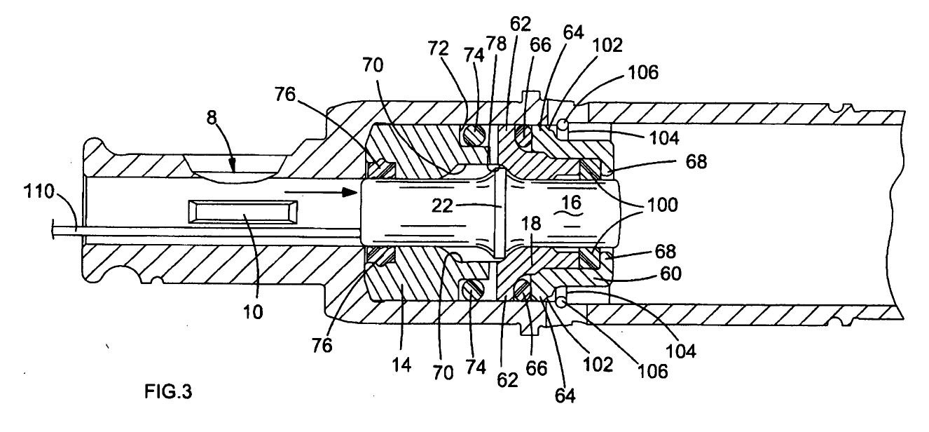

The assembly comprising the bearing beat piece 14, the bush damper 18, the ram catcher 60, the seal 76, the O rings 74, 66 and the ram catcher ring 100 are assembled into one beat piece and ram catcher assembly. Then, the beat piece and ram catcher assembly is inserted into the second section 6 of the spindle 2 through the end of the second section 6 and slid using a tool (not shown) within the spindle along the length of the second section 6 until abuts the shoulder 20, the bearing beat piece 14 being located adjacent to and in contact with the shoulder as shown in FIG. 2. As the, the beat piece and ram catcher assembly is slid to this position, it passes over the groove 104 and leaves it exposed when the , the beat piece and ram catcher assembly is adjacent the shoulder 20. The circlip 106 is then inserted into the same end of the spindle 2 as the beat piece and ram catcher assembly, and then is slid within the spindle along the second section 6 of the spindle 2 until in engages the groove 104 within the second section 6 of the spindle 2 wherein it locates within the groove 104 due to the outward biasing force of the circlip 106. The circlip 106 is thus prevented from sliding in either direction by the groove 104. A tool 110, such as a metal rod, is then inserted into the end of the spindle in the first section 4 and pushed into the spindle until it engages with the beat piece 16. Using the tool 110, a force is applied to the beat piece 16 which causes the beat piece 16 to slide within the beat piece support structure until the rib 22 engages the rear wall of the ledge 78 of the bush damper 18 as shown in FIG. 3. A force is continued to be applied to the beat piece 16 by the tool 110, pushing the whole of the beat piece and ram catcher assembly along the second section 6 of the spindle 2 until ram catcher engages with the circlip. At this point, the circlip 106 is located within the annular recess 102 formed around the ram catcher 60 as shown in FIG. 4. This locks the circlip 106 in the groove 104 as it is prevented from leaving it by the wall of the annular recess 102 A space 112 is left between the shoulder 20 and the bearing beat piece 14.

The beat piece and ram catcher assembly can be removed in the reverse manner. Using a tool inserted through the end of the second section 6 of the spindle 2, the beat piece and ram catcher assembly can be slid along the second section 6 of the spindle towards the first section 4 until the bearing beat piece 14 engages the shoulder 20, the circlip 106 now having been removed from the annular recess 102. Thus the circlip is no longer locked into the groove 104. The circlip 106 is removed from the groove 104 and slid along the spindle until it exits the end in the second section 106. A tool is then inserted into the end of the spindle in the first section and pushed into the spindle until it engages with the beat piece 16. Using the tool, a force is applied to the beat piece 16 which causes the beat piece 16 to slide within the beat piece support structure until the rib engages the rear wall of the ledge of the bush damper 18. A force is continued to be applied to the beat piece 16 by the tool, pushing the whole of the beat piece and ram catcher assembly along the second section 6 of the spindle 2 until it is pushed out of the spindle 2 through the end in the second section.

It will be appreciated that the the beat piece and ram catcher assembly can be assembled inside the spindle 2 by first sliding in the bearing beat piece 14 with the seal 76 and O ring 74 until it abuts the shoulder, then inserting the beat piece 16 into both the spindle and bearing beat piece 14, then sliding in the bush damper 18 until it abuts the bearing beat piece 14 and then sliding in the ram catcher with the O ring 66 and ram catcher ring 60 until they abut against the bush damper 18. The beat piece and ram catcher assembly is then pushed backwards to engage the circlip 106 as described previously.

1. A method of assembling a spindle assembly comprising:
a tubular spindle (2);
a beat piece structure which is capable of being located and slid within a part (6) of the spindle (2);
a stop mechanism (20) located within the spindle (2) which prevents the beat piece structure from sliding past it when the beat piece structure is located in and sliding within the spindle (2);
and a retention mechanism capable of being located within the spindle (2) and which prevents the beat piece structure from sliding past it when the beat piece structure is located in and sliding within the spindle (2);
wherein the method comprises the steps of:
i) inserting the beat piece structure into the spindle through one end of the spindle and sliding it along the spindle (2) in one direction until it abuts the stop mechanism (20);
ii) inserting the retention mechanism into the spindle through the same end of the spindle (2) until it locates at a predetermined position;
iii) sliding the beat piece structure in the opposite direction away from the stop mechanism (20) until it abuts the retention mechanism 106.

2. A method as claimed in claim 1 wherein the beat piece structure is slid away from the stop mechanism (20) until it abuts the retention mechanism by the insertion of a tool into the end of the spindle (2) opposite to that through which the beat piece structure was inserted into the spindle (2) until it engaged with the beat piece structure wherein a tool pushes the beat piece structure away from the stop mechanism (20) to the retention mechanism.

3. A method as claimed in any one of claims 1 or 2 wherein the method further comprises the step of assembling the beat piece structure prior to inserting it into the spindle (2).

4. A method as claimed in any one of claims 1 or 2 wherein the method further comprises the step of inserting the component parts of the beat piece structure into the spindle sequentially in a predetermined order and assembling the beat piece structure within the spindle 2.

5. A method as claimed in any one of claims 1, 2, 3 or 4 wherein the beat piece structure comprises a beat piece support structure in which is mounted a beat piece 16.

6. A method as claimed in claim 5 wherein the beat piece structure is slid away from the stop mechanism (20) until it abuts the retention mechanism by the tool engaging the beat piece.

7. A method as claimed in claim 6 wherein the urging force exerted by the tool onto the beat piece is transferred from the beat piece to the beat piece support structure to cause it to slide within the spindle.

8. A method as claimed in any one of claims 5 to 7 wherein the beat piece support structure comprises a bearing beat piece 14 and a bush damper 18.

9. A method as claimed in any one of claims 1 to 8 wherein the retention mechanism is a circlip 106 which engages with a groove 104 within the spindle.

10. A method as claimed in claim 9 wherein the step of inserting the retention mechanism into the spindle through the same end of the spindle (2) until it locates at a predetermined position comprises the step of inserting the circlip into the spindle until it engages with the groove in the spindle.

11. A method as claimed in any one of claims 1 to 10 wherein the beat piece structure comprises a recess into which the circlip 106 slides to lock the circlip in the groove when the beat piece structure is slid in the opposite direction away from the stop mechanism (20) until it abuts the circlip 106.

12. A method as claimed in any one of claims 1 to 11 wherein the beat piece structure further comprises a ram catching mechanism 60, 100 in which is formed the recess 104.

13. A method as claimed in claim 12 wherein the ram catching mechanism comprises a ram catcher 60 and a ram catcher ring 100.

14. A method as claimed in any one of claims 1 to 13 wherein the stop mechanism comprises a shoulder 20 formed in the spindle 2.

15. A spindle assembly manufactured using the method as claimed in any one of claims 1 to 14.

16. A method of disassembling a spindle assembly comprising:
a tubular spindle (2);
a beat piece structure located in and capable of being slid within a part (6) of the spindle (2);
a stop mechanism (20) located within the spindle (2) on one side of the beat piece structure with a space 112 there between and which prevents the beat piece structure from sliding past it when the beat piece structure is slid within the spindle (2);
and a removeable retention mechanism located within the spindle (2) adjacent the beat piece structure on the opposite side of it to that of the stop mechanism 20 which prevents the beat piece structure from sliding past;
wherein the method comprises the steps of:
i) sliding the beat piece structure in a direction away from the retention mechanism 106 into the space 112 between the beat piece structure and the stop mechanism 20 until it abuts the stop mechanism 20
ii) removing the retention mechanism from the spindle;
iii) removing the beat piece structure from the spindle through the same end of the spindle (2) as the retention mechanism.

17. A method as claimed in claim 16 wherein the beat piece structure comprises a beat piece support structure in which is mounted a beat piece 16.

18. A method as claimed in claim 17 wherein the beat piece support structure comprises a bearing beat piece 14 and a bush damper 18.

19. A method as claimed in any one of claims 16 to 18 wherein the retention mechanism is a circlip which engages with a groove within the spindle.

20. A method as claimed in any one of claims 16 to 19 wherein the beat piece structure comprises a recess in which the circlip 106 is located to lock the circlip into the groove when the beat piece structure sliding the beat piece is abuted by the circlip.

21. A method as claimed in any one of claims 16 to 20 wherein the beat piece structure further comprises a ram catching mechanism 60, 100 in which is formed the recess 104.

22. A method as claimed in claim 21 wherein the ram catching mechanism comprises a ram catcher 60 and a ram catcher ring 100.

23. A method as claimed in any one of claims 16 to 22 wherein the stop mechanism comprises a shoulder formed in the spindle 2.

24. A spindle assembly comprising:
a tubular spindle (2);
a beat piece structure located in and capable of being slid within a part (6) of the spindle (2);
a stop mechanism (20) located within the spindle (2) on one side of the beat piece structure and which prevents the beat piece structure from sliding past it when the beat piece structure is slid within the spindle (2);
and a removeable retention mechanism located within the spindle (2) adjacent the beat piece structure on the opposite side of it to that of the stop mechanism 20 which prevents the beat piece structure from sliding past;
wherein a space is provided between the stop mechanism and the beat piece structure and the retention mechanism abuts against the retention mechanism.

25. A spindle assembly as claimed in claim 24 wherein the beat piece structure comprises a beat piece support structure in which is mounted a beat piece 16.

26. A spindle assembly as claimed in claim 25 wherein the beat piece support structure comprises a bearing beat piece 14 and a bush damper 18.

27. A spindle assembly as claimed in any one of claims 24 to 26 wherein the retention mechanism is a circlip which is engaged with a groove within the spindle.

28. A spindle assembly as claimed in any one of claims 24 to 27 wherein the beat piece structure comprises a recess in which the circlip 106 is located to lock the circlip into the groove.

29. A spindle assembly as claimed in any one of claims 24 to 28 wherein the beat piece structure further comprises a ram catching mechanism 60, 100 in which is formed the recess 104.

30. A spindle assembly as claimed in claim 29 wherein the ram catching mechanism comprises a ram catcher 60 and a ram catcher ring 100.

31. A spindle assembly as claimed in any one of claims 24 to 30 wherein the stop mechanism comprises a shoulder formed in the spindle 2.
